(19) United States
(12) Patent Application Publication
(10) Pub. No.: US 2009/0205230 A1
(43) Pub. Date: Aug. 20, 2009

(54) PAPER BASED COMMUNICATION MEDIUM DISPOSED WITH SONIC TRANSDUCERS

(75) Inventor: Franciscus August Aaron Driessen, Amsterdam (NL)

Correspondence Address: KNOBBE MARTENS OLSON & BEAR LLP, 2040 MAIN STREET, FOURTEENTH FLOOR, IRVINE, CA, 92614, US

(73) Assignee: FUN Industries B.V., Utrecht (NL)

(21) Appl. No.: 12/208,725

(22) Filed: Sep. 11, 2008

(30) Foreign Application Priority Data
Feb. 18, 2008 (NL) NL1035039

(51) Int. Cl. G09F 1/04

(52) U.S. Cl. 40/124.03

(57) ABSTRACT

The present invention concerns a substantially paper based communication medium disposed with two or more spatially separated sonic transducers co-operatively connected to integrated electronic components configured to generate and direct audio sound signals independently to the two or more sonic transducers upon activation, simultaneously and/or sequentially.

### CROSS-REFERENCE TO RELATED APPLICATIONS

This application claims priority to NL 1035039 filed Feb. 18, 2008.

### FIELD OF THE INVENTION

The present invention relates to the field of paper based communication media, particularly greeting cards, disposed with two or more sonic transducers that are configured for simultaneous and/or sequential activation.

### BACKGROUND OF THE INVENTION

Paper-based communication media, particularly greeting cards, can provide the recipient with an audio message that is typically reproduced upon a mechanical activation, such as opening the card or pressing an activation button. A problem associated with such card is the difficultly of engaging the recipient with the information printed thereon. While the audio reproduction attracts the attention of the recipient, it also acts as a distraction against examining the contents e.g. against reading the message printed in a greeting card.

There is a need in the art for a paper based communication medium that provides not only the appeal of audio stimulation, but also compels the recipient to look at the written information printed on the medium. The present invention aims to overcome the problems associated with the art.

### SUMMARY OF THE INVENTION

The present invention concerns a substantially paper based communication medium having integrated electronic components configured to generate and direct audio sound independently to two or more sonic transducers integrated in the paper medium. The two or more sonic transducers are preferably placed spatially apart in the medium, thereby providing a spatial aural effect. The effect may be stereophonic, or more preferably, may be linked with an image disposed on the medium, giving the impression of a sound emanating from each image so providing a spatial audio effect that may give educative effect and/or amusement, while attention is drawn to the contents of the card.

The electronic components may include a memory component configured to store one or more digitalized sound samples. The digitized sounds may be stored at the time of production or may be stored after production.

The invention may contain additional components that enable the display of light-effects correlating to and timed with regard to the spatially dispersed reproduced sound. The electronic components that enable reproduction of sound effects and correlating light effects are known and available to the skilled person.

The invention reproduces the stored sounds in a way that exploits the innate human spatial experience of sound, enriching the user experience of the product as a synergetic combination of visual and aural signals.

One embodiment of the invention is a substantially paper based communication medium disposed with two or more spatially separated sonic transducers co-operatively connected to integrated electronic components configured to generate and direct audio sound signals independently to the two or more sonic transducers upon activation, simultaneously and/or sequentially.

One embodiment of the invention is a medium as described above, disposed with at least two spatially distinct visual information elements, and whereby each sonic transducer is positioned proximal to each of said information elements.

Another embodiment of the invention is a medium as described above, wherein the audio sound signals are directed independently to the two or more spatially separated sonic transducers sequentially, and the sonic transducers are activated in turn.

Another embodiment of the invention is a medium as described above, wherein the audio sound signals are directed independently to three or more spatially separated sonic transducers sequentially, and at least two transducers are activated twice before the others have been activated.

Another embodiment of the invention is a medium as described above, further disposed with one or more light emitting components configured to illuminate in synchronicity with the audio sound reproduction.

Another embodiment of the invention is a medium as described above, wherein the integrated electronic components include a solid state memory for storage of digitized audio sound.

Another embodiment of the invention is a medium as described above, wherein the activation of the sonic transducers is effected by a single electrical contact.

Another embodiment of the invention is a medium as described above, that is a greeting card.

Another embodiment of the invention is a medium as described above, where the greeting card is disposed with an illustration of two or more cartoon characters, and one sonic transducer is disposed behind each of said two or more cartoon characters.

### FIGURE LEGENDS

FIG. 1 is an illustration of an opened-out, paper based communication medium that is a greeting card, containing a housing for electrical components for sound reproduction and two sonic-transducers positioned apart.

FIG. 2 is an illustration of the paper based communication as in depicted in FIG. 1 in a folded condition showing two panels provided with printed information.

FIG. 3 is an illustration of an opened-out, paper based communication medium that is a greeting card, containing a housing for electrical components for sound reproduction and three sonic-transducers positioned apart.

FIG. 4 is an illustration of the paper based communication as in depicted in FIG. 3 in a folded condition showing three panels provided with printed information.

FIG. 5 depicts a circuit diagram for connecting two sonic-transducers to the electrical components of the invention.

FIG. 6 depicts an alternative circuit diagram for connecting two sonic-transducers to the electrical components of the invention.

FIG. 7 depicts a circuit diagram an alternative circuit diagram for connecting two sonic-transducers to the electrical components of the invention.

### DETAILED DESCRIPTION OF THE INVENTION

Unless defined otherwise, all technical and scientific terms used herein have the same meaning as is commonly understood by one of skill in the art. All publications referenced herein are incorporated by reference thereto. All United States patents and patent applications referenced herein are incorporated by reference herein in their entirety including the drawings.

The articles “a” and “an” are used herein to refer to one or to more than one, i.e. to at least one of the grammatical object of the article. By way of example, “an integrated circuit” means one integrated circuit or more than one integrated circuit.

The recitation of numerical ranges by endpoints includes all integer numbers and, where appropriate, fractions subsumed within that range (e.g. 1 to 5 can include 1, 2, 3, 4 when referring to, for example, a number of integrated circuits, and can also include 1.5, 2, 2.75 and 3.80, when referring to, for example, measurements). The recitation of end points also includes the end point values themselves (e.g. from 1.0 to 5.0 includes both 1.0 and 5.0).

The present invention concerns a substantially paper based communication medium disposed with one or more integrated electronic components and two or more sonic transducers, where by the integrated electronic components are configured to reproduce audio sound independently to the two or more sonic transducers. The electronic components may be configured to send sound signals simultaneously or sequentially to the two or more sonic-transducers.

By sequentially, it is meant that the sound signals sent to one sonic transducer commences automatically after sound signals have been sent to another sonic transducer. The duration of the respective sounds may overlap, or more preferably, the electronic components are configured such that sound emitted by one sonic transducer does not commence until after the sound emitted by another transducer has ended. In other words, in a preferred embodiment of the invention, the sounds emitted by the sonic transducers do not overlap. Sequential activation of the sonic transducers includes activating each transducer in turn (e.g. A-B-C-D where A, B, C and D are each sonic transducers). It also includes activating some transducers twice in a sequence before other have been activated (e.g. A-B-A-B-C-D where A, B, C and D are each sonic transducers).

By simultaneously, it is meant that the sound signals are sent simultaneous to both sonic transducers at the same time. Where a stereophonic effect is desirable, the sound generated by the components and directed to each transducer will provide the requisite effect, for instance having been captured or mixed stereophonically, or processed (e.g. using channel delays) to give a pseudo-stereophonic effect.

The two or more sonic transducers are preferably spatially placed apart in the medium, thereby providing a spatial aural effect. As mentioned above the effect may be stereophonic i.e. giving the impression of realism, or more preferably, may be linked with an image reproduced on the medium, giving the impression of a sound emanating from the image present on a surface of the medium so providing a spatial audio illusion.

A substantially paper based communication medium refers to any communication medium formed from a carrier constructed primarily from one or more sheets of thick paper, cardboard or similar material. It includes, but is not limited to a greeting card, a product or promotional leaflet, book-like product, booklet, bookmark, calendar, or poster etc. The medium will typically be disposed with information that can be read e.g. text, numbers or illustrations.

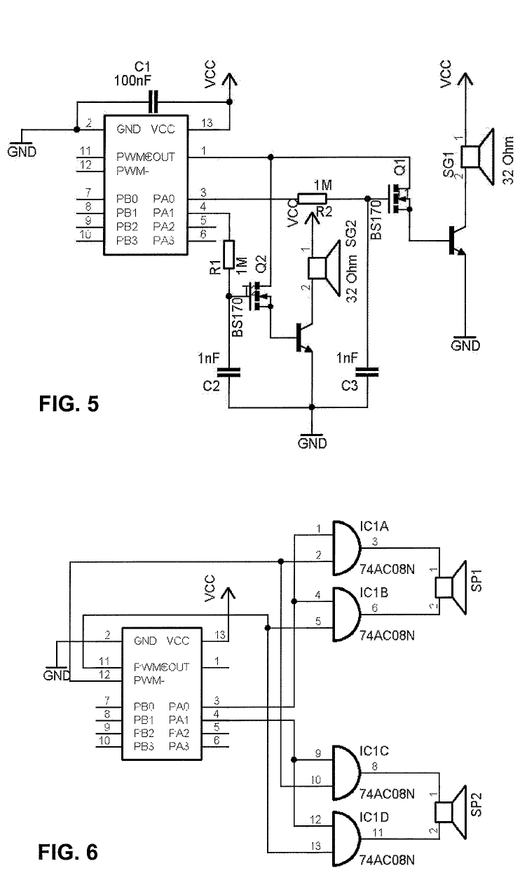

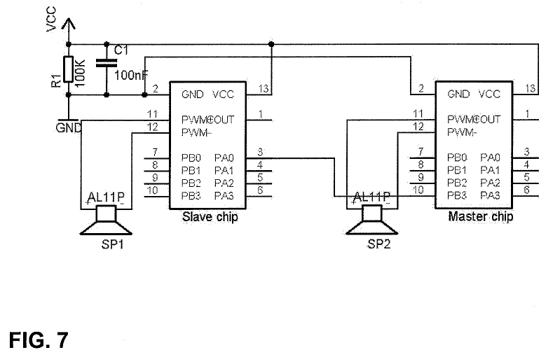

The electronic components disposed on or in the medium may include a processing component such as one or more integrated circuits configured to convert digitalized sound samples stored in a memory into analogue audio signals for output through the two or more sonic transducers. The memory preferably stores a selection of digitized sounds. The electronic components may also include a control component, configured to control which sonic transducer is activated, at which time point and the duration of activation. The electronic components may also include an amplification component for boosting the analogue audio output from the processing component. Alternatively or in addition, the electronic components may include one or more analogue sound generating components, and an optional amplification component for boosting the analogue audio output from the analogue sound generating component. The electronic components are co-operatively connected to function in accordance with the invention. One or more electronic components may be integrated into the same circuit board or integrated into a single integrated circuit. The skilled person would readily be able to prepare the medium in accordance with the guidance provided herein using standard components and ordinary practices in the art. For general guidance only, circuit diagrams illustrated in FIGS. 5 to 7 show possible schemes for connecting electrical components according to the invention.

The sonic transducers are configured to receive analogue electrical signals from the electrical components, and reproduce them as sound energy, responsive to the electrical signals. The sound energy is preferably within the frequency range of ordinary human hearing. The sonic transducers may be any, including piezo-electric transducers and magnetic coil transducers; preferably they are piezo-electric audio transducers. The number of sonic transducers may be 2, 3, 4, 5, 6, 7, 8, 9, 10 or more, or a number in the range between any two of the aforementioned values. The sonic transducers are preferably disposed in or on the medium in a spatially separated manner.

Additional electronic components include a power source, to power the electronic components. The power source is preferably a battery, such as a button battery, though it may equally be a solar panel having a flat construction, optionally with a rechargeable battery. An additional electrical component may be one or more electrical contacts (e.g. 1, 2, 3, 4 or 5) to activate the reproduction of the sounds. Sound may be triggered, or example, by depression of an electrical contact button or upon mechanical opening of a greeting card or book. In a preferred aspect of the invention, the medium is disposed with a single electrical contact that triggers the simultaneous or sequential activation of the sonic transducers.

Besides comprising two or more sonic transducers, the medium may be disposed with one or more (e.g. 2, 3, 4, 5, 6, 7, 8, 9, 10, 11, 12, 13, 14, 15, 16, 17,18, 19, 20 or more) light-emitting transducers. The light emitting transducer may be, for example, a light emitting diode or an electroluminescent panel or sheet. It may be co-operatively connected to the electronic components, e.g. the control component, configured to control the timing and/or intensity of the illumination by the light-emitting transducers. The timing and/or intensity of the illumination may be synchronized with audio emissions from the sonic transducers.

The medium is disposed with the aforementioned electronic components, meaning that it carries the electronic components in or on the medium surface. The components may be attached using any means including adhesive, adhesive tape, a staple, a shallow screw, a rivet. The components may be concealed by placement on a surface reverse to that used to display information. Most preferably, the electrical components are sandwiched between two surfaces of the medium e.g. disposed between two sheets of card. Apertures may be present in the medium to allow the passage of sound and/or light energy. According to one aspect of the invention, the paper based medium comprises one or more pages bearing visual information.

The electronic components and two or more sonic transducers may be configured in variety of ways. For instance, the electronic components may be configured to send sound signals simultaneously and/or sequentially to the two or more sonic-transducers that are mounted in a spatially dispersed manner. Visual information may be provided on the medium at a spatial position that corresponds to the mounting of a transducer; sound emitted by a transducer may correspond with such spatially distinct visual information element. For instance, a medium carrying an illustration of a male face and female face may be disposed with a transducer mounted behind each face, and the sound emitted by the respective transducers correspond to male and female voices. Where light-effects are present, the electronic components may be configured to displayed light-effects that support and enrich both the reproduced sounds and corresponding spatial dispersion of the activated sonic-transducers.

In a preferred aspect of the invention, the paper based communication medium of the invention comprises 1, 2, 3 or 4 pages, each bearing visual information and comprising a processing component containing digitized sound information, for the controlling and driving the light-emitting components and for the controlling and driving of two or more sonic-transducers; a light-emitting component which emit light when driven; two or more sonic-transducers that produce sound when driven.

Preferably, a stored sound or library of stored sounds correspond with a spatially distinct visual information element (e.g. illustration of a man) provided on the pages of the medium; where several spatially distinct visual information element are provided (e.g. illustration of a man and of a woman), there may be a several libraries of stored sounds, one for each spatially distinct visual information element.

By way of the above mentioned components, the invention provides for a paper based communication medium containing an electronic components that may be disposed within a single integrated circuit that enables the play-back of sound and the control of light emitting components and for control of the reproduction of the sound through two or more sonic-transducers, with the characterization that the spatially dispersed playback of the sounds and the corresponding light effects support and enrich the visual information applied to the respective parts of the medium.

The invention further provides for a method to support and enrich visual information applied to a paper communication medium. The method comprises:
providing a paper based communication medium comprising one or more pages that are physically bound to each other and each bearing visual information,
playing back sound electronically stored in electronic components in the paper based communication medium, said sound reproduced either sequentially through two or more sonic-transducers, and/or simultaneously through two or more sonic transducers, and optionally simultaneously driving light-emitting components, where each sound and/or light-effect is synchronized. The synchronization supports or enriches the visual information applied to a page of the paper based communication medium and induces a spatial sensory experience for the user by means of applied sound- and light effects.

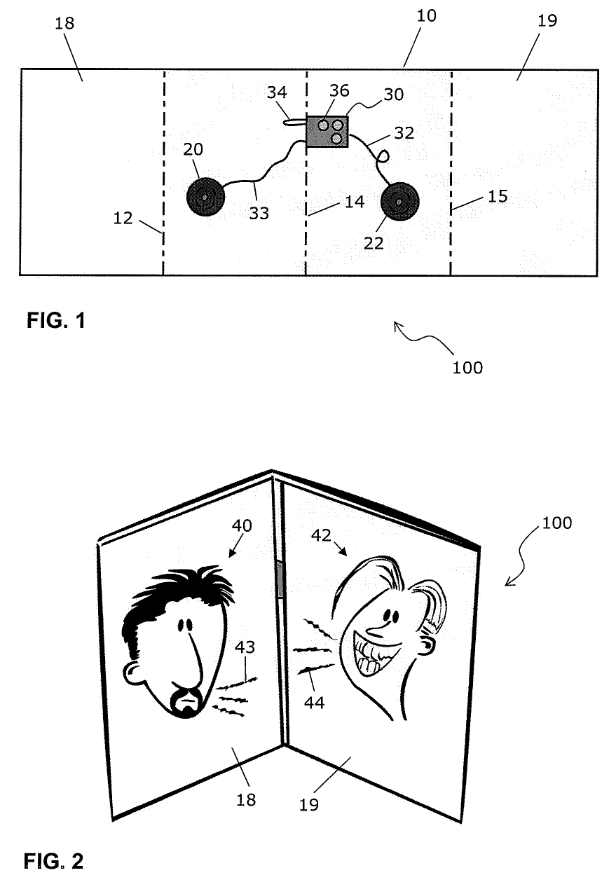

Examples of implementations of the invention are provided by way of illustration, in FIGS. 1 to 4.

FIG. 1 shows an illustration of an unfolded greeting card disposed with two sonic transducers 20, 22 connected by electrical cables 32, 33 to a housing 30 containing a processing component, solid-state memory storing digitized sounds, control component, amplifying component, an activating electrical contact 34 and a power supply 36 co-operatively connected. The housing 30, two sonic transducers 20, 22 and cables 32, 33 are concealed behind flaps 18, 19 when the card is folded along lines 12 and 15. The folded and opened card (FIG. 2) is illustrated with two spatially distinct visual elements i.e. cartoon characters 40, 42 on the reverse of the flaps 18, 19 whose position is proximal to the sonic transducers 20, 22 i.e. each sonic transducer lies behind each cartoon character. When the card is activated, the cartoon characters 40, 42 seem to have a dialogue 43, 44—each character displayed in the card 100 being voiced by a separate sonic-transducer positioned behind the character's illustration.

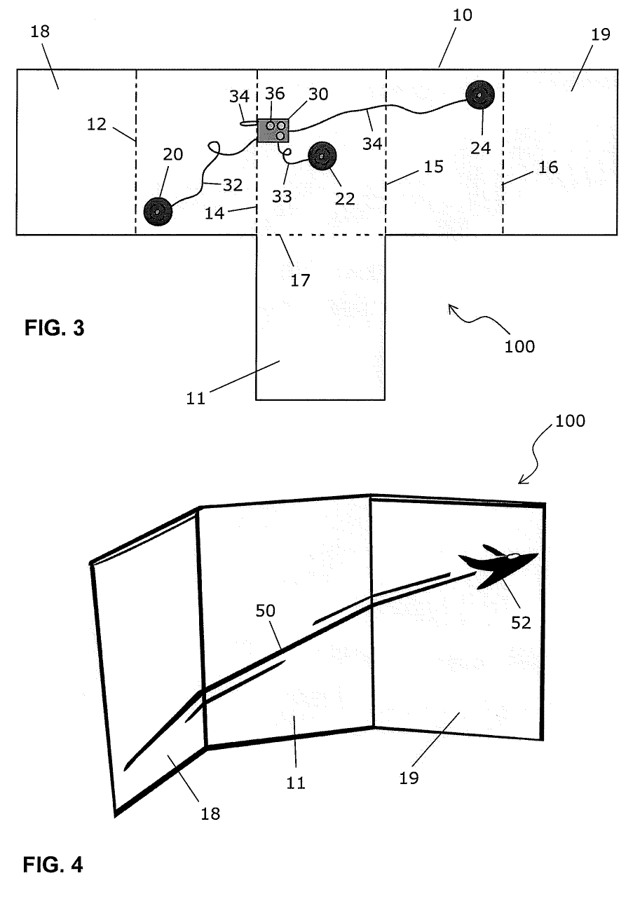

FIG. 3 shows an illustration of an unfolded greeting card disposed with three sonic transducers 20, 22, 24 connected by electrical cables 32, 33, 34 to a housing 30 containing a processing component, solid-state memory storing digitized sounds, control component, amplifying component, an activating electrical contact 34 and a power supply 36 co-operatively connected. The housing 30, three sonic transducers 20, 22, 24 and cables 32, 33, 34 are concealed behind flaps 11,18, 19 when the card is folded along lines 12, 15, 16, 17. The folded and opened card (FIG. 4) is illustrated with an airplane 52 leaving a vapor trail 50 on the reverse of the flaps 11, 18, 19, the vapor trail 50 spanning the card construction, the three sonic transducers 20, 22, 24 positioned at either end of and at the midsection of the vapor trail 50. The card, upon activation reproduces the sound of an airplane in such a way that the user of the card experiences movement of the sound from one sonic transducer to the other; the illusion is thereby given that the sound emanates from the airplane moving, for example, from left to right.

1. A substantially paper based communication medium disposed with two or more spatially separated sonic transducers co-operatively connected to integrated electronic components configured to generate and direct audio sound signals independently to the two or more sonic transducers upon activation, simultaneously and/or sequentially.

2. Medium according to claim 1, wherein the medium is disposed with at least two spatially distinct visual information elements, and whereby each sonic transducer is positioned proximal to each of said information elements.

3. Medium according to claim 1, wherein the audio sound signals are directed independently to the two or more spatially separated sonic transducers sequentially, and the sonic transducers are activated in turn.

4. Medium according to claim 1, wherein the audio sound signals are directed independently to three or more spatially separated sonic transducers sequentially, and at least two transducers are activated twice before the others have been activated.

5. Medium according to claim 1, further disposed with one or more light emitting components configured to illuminate in synchronicity with the audio sound reproduction.

6. Medium according to claim 1, wherein the integrated electronic components include a solid state memory for storage of digitized audio sound.

7. Medium according to claim 1, wherein the activation of the sonic transducers is effected by a single electrical contact.

8. Medium according to claim 1 that is a greeting card.

9. Medium according to claim 8 where the greeting card is disposed with an illustration of two or more cartoon characters, and one sonic transducer is disposed behind each of said two or more cartoon characters.
